(19) United States
(12) Patent Application Publication
(10) Pub. No.: US 2014/0325779 A1
(43) Pub. Date: Nov. 6, 2014

(54) Brush holding device

(71) Applicant: Amy Dansby, Taos, NM (US)

(72) Inventor: Amy Dansby, Taos, NM (US)

(21) Appl. No.: 13/887,388

(22) Filed: May 6, 2013

(51) Int. Cl. A46B 17/02; F16M 13/02; A46B 17/04

(52) U.S. Cl. CPC A46B 17/02; A46B 17/04; F16M 13/02
USPC 15/168; 15/159.1; 248/110

(57) ABSTRACT

A brush holding device for holding a brush may include a top surface, a front surface connected to the top surface, a pair of opposing side surfaces connected to the top surface and the front surface, a bottom surface connected to the pair of side surfaces and the front surface; and a back surface connected to the top surface and the pair of side surfaces.

### FIELD OF THE INVENTION

The present invention relates to holders and more particularly to a holder for makeup brushes.

### BACKGROUND

Makeup brushes are used to apply makeup, such as foundation or various other powder forms of cosmetics, and come in a wide variety of shapes, sizes, and configurations. These brushes typically come packaged in a plastic cover to enclose the bristles of the makeup brush to prevent damage to the bristles prior to sale of the brush. Before use, the plastic cover is discarded as it is generally unsuitable for later protecting the bristles of the makeup brush. The plastic cover is generally a low quality material that tightly binds the bristles of the brush during transport and prior to sale.

The included plastic cover is unsuitable to store the makeup brush after the initial use because it is very difficult to reattach the plastic cover, which also compresses the bristles of the makeup brush. Over time, repeated use of a makeup brush allows the bristles to expand, providing a better user experience because makeup can be more easily and evenly spread across the surface of the skin. Placing the makeup brush into the plastic cover recompresses the bristles and reduces the benefits of using a makeup brush with full bristles.

Previous solutions for transporting a makeup brush require the user to place the makeup brush in a larger makeup bag, or resealable plastic bag, and place this large bag inside of a purse or other carrying bag. This method is generally cumbersome and undesirable because it consumes too much space within the purse or bag. Additionally, the makeup contained on the bristles may be dislodged during transport, which results in makeup covering the handle or other portions of the brush that may make the brush difficult or messy to use. The makeup brush may also collect dirt and grime during transport, which could transfer dirt and grime to the face during subsequent use. If the brush is simply placed in a purse, or other article, the brush and/or article is likely to become damaged or stained.

### SUMMARY

A brush holding device for holding a brush may include a top surface, a front surface connected to the top surface, a pair of opposing side surfaces connected to the top surface and the front surface, a bottom surface connected to the pair of side surfaces and the front surface; and a back surface connected to the top surface and the pair of side surfaces.

The brush holding device may include a brush holder aperture which extends from the top surface to the bottom surface.

The brush holding device may include a brush positioned within the brush holder apparatus.

The brush holding device may include a brush holding ring positioned on bristles of the brush.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the brush holding device of the present invention;

FIG. 2 illustrates a top view of the brush holding device of the present invention;

FIG. 3 illustrates a front view of the brush holding device of the present invention;

FIG. 4 illustrates a side view of the brush holding device of the present invention;

FIG. 5 illustrates a another side view of the brush holding device of the present invention;

FIG. 6 illustrates a perspective view of the brush ring of the present invention;

FIG. 7 illustrates a side view of the brush ring of the present invention;

FIG. 8 illustrates a top view of the brush ring of the present invention;

FIG. 9 illustrates a perspective view of the brush holding device 100

FIG. 10 illustrates a perspective view of the brush holding ring and brush of the present invention;

FIG. 11 illustrates a perspective view of the brush holding ring and brush of the present invention.

### DETAILED DESCRIPTION

The present invention provides a brush holding device 100 which may be used to store cosmetics brushes or artist paint brushes in at least an upside down position for example the bristles 155 of the brush 150 are positioned below the handle 151 and ferrule 153 while drying after cleaning and use to prevent water damage to the glue inside the ferrule 153 while the bristles 155 of the brush 150 are drying.

The present invention additionally includes a disk/ring 160 which includes a central aperture 161 which may cooperate with the bristles 155 of the brush 150 and which may extend through the ring 160 in order to hold the bristles 155 of the brush 150 substantially together in order to isolate the bristles 155 of the brush 150 from the bristles 155 of a second brush 150. The ring 160 by virtue of the aperture 161 may slip over the brush tuft 155 to hold the bristles in place while drying to prevent fraying.

The brush holding device 100 hangs and holds by a friction fit cosmetics brushes 150 or artist paint brushes in an “upside down” (handle side up) position for drying or storage. This position encourages liquids which may remain in the bristles 155 to flow downwards via gravity away from the handle 151 and ferrule 153 towards the tuft 155 to prevent damage to the ferrule 153 and glue which hold the tuft 155 as well as other areas.

A disc-shaped apparatus which may be referred to as the brush ring 160 may include a hole in the center aperture 161 and which slips over the brush handle 151 by a friction fit with the side wall of the brush holder aperture 157 and may attach to the brush handle 151 approximately down around the brush tuft/ferrule 153 and holds brush tuft/bristles into shape so as to prevent fraying while the bristles 155 are drying.

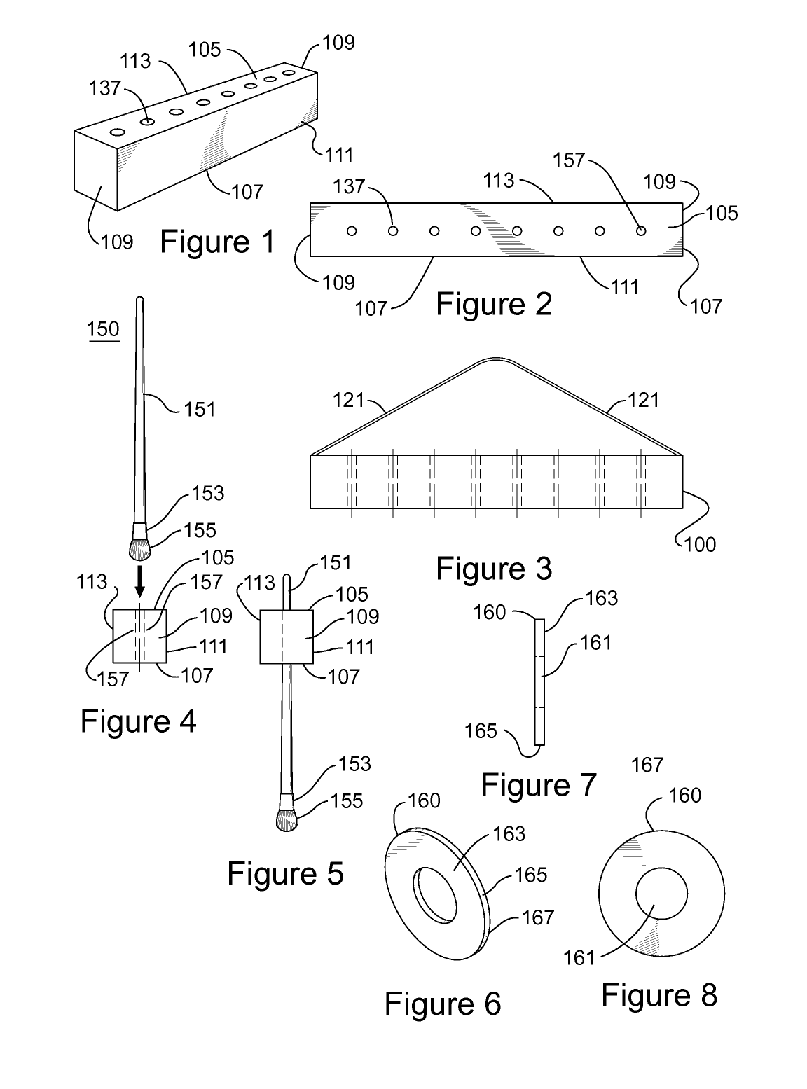

The brushing holding device 100 as illustrated in FIG. 1 may include a front surface 111 which may be opposed to a back surface 113 and may be connected to a pair of opposing side surfaces 109, a top surface 105 and a bottom surface 107, the top surface 105 may be connected to the pair of opposing side surfaces 109, the front surface 111, and the back surface 113, the bottom surface 107 may be connected to the pair of opposing side surfaces 109, the front surface 111 and the back surface 113, the back surface 113 may be connected to the top surface 105, the bottom surface 107, and the side surface 109, and the pair of side surfaces 109 may be connected to the top surface 105, the bottom surface 107, front surface 111 and the back surface 113.

The brush holding device 100 may be substantially solid and may be formed from plastic, metal, wood or other appropriate material and may include a plurality of brush holder apertures 157 to hold the brushes 150 and may extend through the brush holding device 100.

FIG. 2 illustrates a top view of the brush holding device 100 and illustrates the top surface 105, the bottom surface 107, the front surface 111, the back surface 113 and the side surface 109. FIG. 2 additionally illustrates the brush holder apertures 157.

The brushing holding device 100 as illustrated in FIG. 3 may include a front surface 111 which may be opposed to a back surface 113 and may be connected to a pair of opposing side surfaces 109, a top surface 105 and a bottom surface 107, the top surface 105 may be connected to the pair of opposing side surfaces 109, the front surface 111, and the back surface 113, the bottom surface 107 may be connected to the pair of opposing side surfaces 109, the front surface 111 and the back surface 113, the back surface 113 may be connected to the top surface 105, the bottom surface 107, and the side surface 109, and the pair of side surfaces 109 may be connected to the top surface 105, the bottom surface 107, front surface 111 and the back surface 113.

The brush holding device 100 may be substantially solid and may be formed from plastic, metal, wood or other appropriate material and may include a plurality of brush holder apertures 157 to hold the brushes 150 and may extend through the brush holding device 100.

FIG. 3 additionally illustrates that the brush holder device 100 may be attached to a wall of a dwelling by a pair of straps 121 which may be connected to the brush holder device 100.

FIG. 4 illustrates a side view of the brush holding device 100 and illustrates the top surface 105, the bottom surface 107, the front surface 111, the back surface 113 and the side surface 109. FIG. 4 additionally illustrates the brush holder apertures 157. FIG. 4 additionally illustrates the brush 150 which may include a handle 151 ferrule 153, and bristles 155 being positioned at a first position to be placed within the brush holder aperture 157.

FIG. 5 illustrates a side view of the brush holding device 100 and illustrates the top surface 105, the bottom surface 107, the front surface 111, the back surface 113 and the side surface 109. FIG. 5 additionally illustrates the brush holder apertures 157. FIG. 5 additionally illustrates the brush 150 which may include a handle 151, ferrule 153, and bristles 155 being positioned at a second position which may be actually within the brush holder aperture 157 of the brush holding device 100.

FIG. 6 illustrates a perspective view of the brush holding ring 160 which may have a substantial circular cross-section and may be formed from metal, wood, plastic or other appropriate material. The brush holding ring 16 may include a center aperture 161 which may extend through the brush holding ring 160, and the wall of the center aperture 161 which may extend around the periphery of the center aperture 161 may cooperate and compress the bristles 155 of the brush 150. The brush holding ring 160 may include a ring top surface 163 which may be connected to a ring periphery surface 165 which may be connected to a ring bottom surface 167.

FIG. 8 illustrates a top view of the brush holding ring 160 which may have a substantial circular cross-section and may be formed from metal, wood, plastic or other appropriate material. The brush holding ring 16 may include a center aperture 161 which may extend through the brush holding ring 160, and the wall of the center aperture 161 which may extend around the periphery of the center aperture 161 may cooperate and compress the bristles 155 of the brush 150.

FIG. 7 illustrates a side view of the brush holding ring 160 which may have a substantial circular cross-section and may be formed from metal, wood, plastic or other appropriate material. The brush holding ring 16 may include a center aperture 161 which may extend through the brush holding ring 160, and the wall of the center aperture 161 which may extend around the periphery of the center aperture 161 may cooperate and compress the bristles 155 of the brush 150.

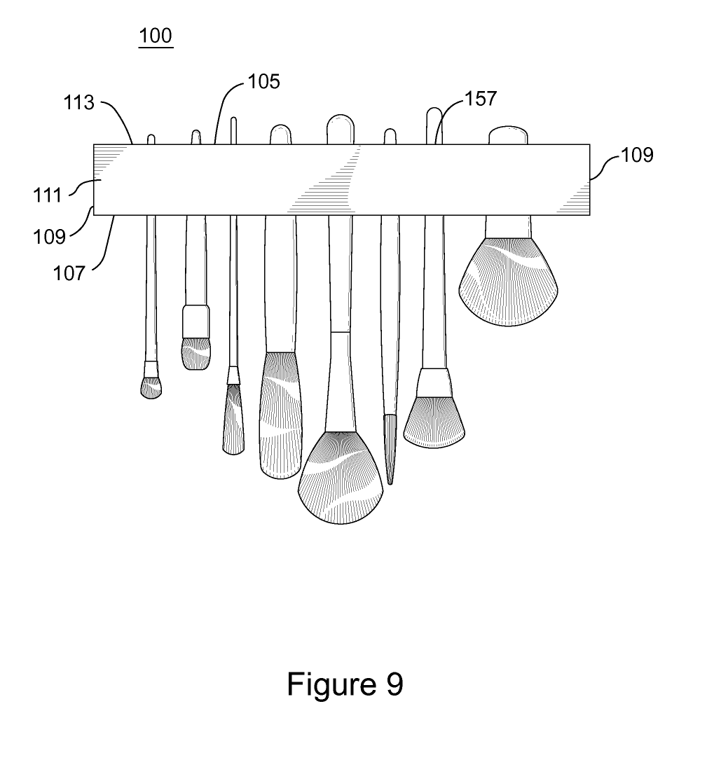

FIG. 9 illustrates a perspective view of the brush holding device 100 and illustrates the top surface 105, the bottom surface 107, the front surface 111, the back surface 113 and the side surface 109. FIG. 5 additionally illustrates the brush holder apertures 157.

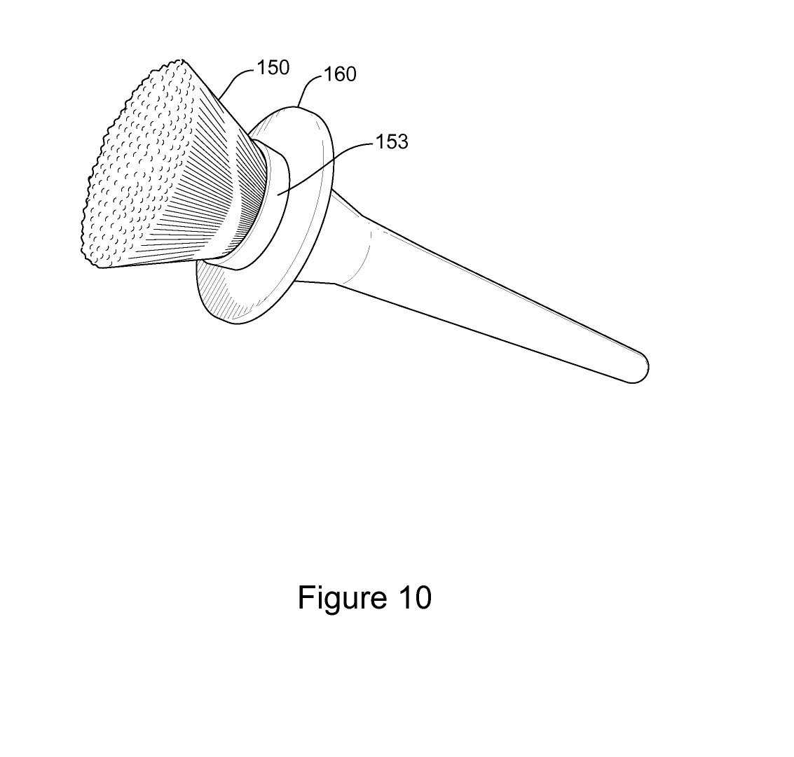

FIG. 10 illustrates the brush 150 with the ring 160 and a first position with the ring 160 being positioned on the ferrule 153.

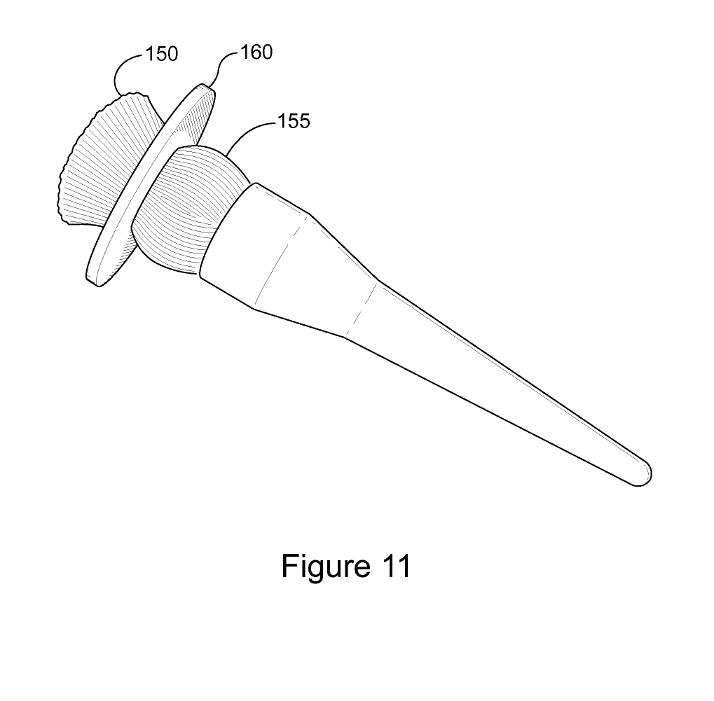

FIG. 11 illustrates the brush 150 with the ring 160 and a second position with the ring 160 being positioned on the bristles 155.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A brush holding device for holding a brush, comprising:
a top surface;
a front surface connected to the top surface;
a pair of opposing side surfaces connected to the top surface and the front surface;
a bottom surface connected to the pair of side surfaces and the front surface; and
a back surface connected to the top surface and the pair of side surfaces;
wherein the brush holding device includes a brush holder aperture which extends from the top surface to the bottom surface.

2) A brush holding device for holding a brush as in claim 1, wherein the brush holding device includes a brush positioned within the brush holder apparatus.

3) A brush holding device for holding a brush as in claim 2, wherein the brush holding device includes a brush holding ring positioned on bristles of the brush.
